(19) United States
(12) Patent Application Publication
(10) Pub. No.: US 2025/0190833 A1
(43) Pub. Date: Jun. 12, 2025

(54) METHOD FOR MOVING MAGIC STATES THROUGH BOUNDARY EXTENSION IN ROTATED SURFACE CODE

(71) Applicant: ELECTRONICS AND TELECOMMUNICATIONS RESEARCH INSTITUTE, Daejeon (KR)

(72) Inventors: Sang-Min LEE, Daejeon (KR); Soo-Cheol OH, Daejeon (KR); Young-Chul KIM, Daejeon (KR); Chei-Yol KIM, Sejong-si (KR); Jin-Ho ON, Sejong-si (KR); Eun-Young CHO, Daejeon (KR); Ki-Sung JIN, Iksan-si (KR); GYU-IL CHA, Daejeon (KR)

(73) Assignee: ELECTRONICS AND TELECOMMUNICATIONS RESEARCH INSTITUTE, Daejeon (KR)

(21) Appl. No.: 18/970,872

(22) Filed: Dec. 5, 2024

(30) Foreign Application Priority Data
Dec. 6, 2023 (KR) 10-2023-0175471
Nov. 19, 2024 (KR) 10-2024-0164871

(51) Int. Cl. G06N 10/40

(52) U.S. Cl. CPC G06N 10/40

(57) ABSTRACT

Disclosed herein is a method for moving magic states through boundary extension in a rotated surface code. The method for moving magic states includes identifying logical data and an ancilla qubit constituting a logical qubit block, and an available magic state logical qubit from a magic state storage space, identifying a type of a movement operation and a bending location during movement by analyzing a path through which the magic state logical qubit is moved to a location of a desired logical ancilla qubit, defining a movement operation process based on boundary extension in consideration of the type of the movement operation and the bending location during the movement, and moving the magic state logical qubit to the location of the logical ancilla qubit in conformity with the movement operation process.

### CROSS REFERENCE TO RELATED APPLICATIONS

This application claims the benefit of Korean Patent Application Nos. 10-2023-0175471, filed Dec. 6, 2023 and 10-2024-0164871, filed Nov. 19, 2024, which are hereby incorporated by reference in their entireties into this application.

### BACKGROUND OF THE INVENTION

### 1. Technical Field

The present disclosure relates generally to a method for moving magic states through boundary extension in a rotated surface code, and more particularly to a method for long-range movement of magic states in a rotated surface code that is a quantum error correction code that supports fault-tolerant quantum computing.

### 2. Description of the Related Art

Quantum computing provides performance much higher than that of a classical computer, but it is difficult to perform large-scale computation due to the problem of a high error rate and low stability. In order to solve this problem, quantum error correction codes have been proposed, and technology for supporting a high error threshold using a smallest number of physical qubits among the quantum error correct codes is a rotated surface code.

Magic states refer to ancilla states required in order to perform an S gate among Clifford gates and a T gate among non-Clifford gates which constitute a universal quantum gate set, with high fidelity. Generally, to improve the fidelity of magic states, distillation is needed, and a lot of resources and cost are required for distillation, and thus construction and creation of a dedicated magic state distillation factory is proposed. Accordingly, the entire structure may be composed of a management zone in which the generated magic states are output and an execution zone in which the quantum gate of the actual quantum circuit is executed. Technology capable of moving magic states at a long distance from the management zone to any location within the execution zone, regardless of the internal structures of the two zones, will be required.

As a method for moving quantum states at a long distance in commonly known surface codes, there is technology such as logical operator joint measurement. This technology may be configured to merge and measure two encoded logical qubits, that is, a sender and a receiver, measure data qubits of the sender, and then split the receiver. Further, as a result of merging and sender measurement, post-processing may be corrected, and the quantum states may be moved to the receiver. Since this technology needs to encode the ancilla qubit that is the receiver into an initial state, space-time cost occur due to such encoding.

Generally, in order to encode the rotated surface code having a code distance d (hereinafter referred to as ‘d’) into the initial state, 2d³ space-time cost is required by summing 2d² space cost and d time cost attributable to error syndrome measurement.

### PRIOR ART DOCUMENTS

### Patent Documents

(Patent Document 1) Korean Patent Application Publication No. 10-2023-0136638, Date of Publication: Sep. 26, 2023 (Title: Interleaving Module for Fault-Tolerant Quantum Computer)

### SUMMARY OF THE INVENTION

Accordingly, the present disclosure has been made keeping in mind the above problems occurring in the prior art, and an object of the present disclosure is to fault-tolerantly move magic states to desired locations using a method for extending the boundary of magic state logical qubits using a routing space composed of uninitialized physical qubits within an arrangement structure composed of logical qubits in a rotated surface code having a two-dimensional (2D) array.

Another object of the present disclosure is to propose a method for moving magic states at a long distance, which can reduce space-time cost compared to a conventional logical operator joint measurement method.

In accordance with an aspect of the present disclosure to accomplish the above objects, there is provided a method for moving magic states in an arrangement structure composed of logical qubits in a rotated surface code having a two-dimensional (2D) array, including identifying logical data and an ancilla qubit constituting a logical qubit block, and an available magic state logical qubit from a magic state storage space; identifying a type of a movement operation and a bending location during movement by analyzing a path through which the magic state logical qubit is moved to a location of a desired logical ancilla qubit; defining a movement operation process based on boundary extension in consideration of the type of the movement operation and the bending location during the movement; and moving the magic state logical qubit to the location of the logical ancilla qubit in conformity with the movement operation process.

The movement operation type may correspond to any one of a Z-boundary extension type in which the magic state logical qubit is extended and moved based on a Z-boundary of the magic state logical qubit, and an X-boundary extension type in which the magic state logical qubit is extended and moved based on an X-boundary of the magic state logical qubit.

The movement operation process may correspond to any one of a Z-boundary extension type unidirectional movement operation in which the magic state logical qubit corresponds to the Z-boundary extension type and is moved only in a horizontal direction, an X-boundary extension type unidirectional movement operation in which the magic state logical qubit corresponds to the X-boundary extension type and is moved only in a vertical direction, a Z-boundary extension type double-bend movement operation in which the magic state logical qubit corresponds to the Z-boundary extension type and is moved while bending 2ⁿ times, and an X-boundary extension type double-bend movement operation in which the magic state logical qubit corresponds to the X-boundary extension type and is moved while bending 2ⁿ times, where n in 2ⁿ may be 1 or more.

Moving the magic state logical qubit may include performing syndrome stabilization by tracking whether a logical error is inserted and by correcting the moved magic state logical qubit using a logical operator depending on a result of tracking.

Moving the magic state logical qubit may further include when the movement operation process is the Z-boundary extension type, initializing an uninitialized physical qubit of a routing space, present from the Z-boundary of the magic state logical qubit to the location of the logical ancilla qubit, to a |0> state; performing syndrome stabilization by applying a Pauli-Z operator to a physical qubit in which a Z-syndrome occurs based on error syndrome measurement; measuring remaining physical qubits, other than the location of the logical ancilla qubit, in a Z-basis; and calculating a multiplication of results measured from the Z-operator of the extended magic state logical qubit, and correcting a quantum state of a stabilized magic state logical qubit by applying a logical X operator to the quantum state when a calculated value corresponds to −1.

Moving the magic state logic qubit may further include when the movement operation process is the Z-boundary extension type double-bend movement operation, bending the magic state logical qubit while maintaining a boundary using a single X-stabilizer, and modifying a stabilizer located at a bending corner to a weight −3 stabilizer.

Moving the magic state logic qubit may further include when the movement operation process is the X-boundary extension type, initializing an uninitialized physical qubit of a routing space, present from the X-boundary of the magic state logical qubit to the location of the logical ancilla qubit, to a |+> state; performing syndrome stabilization by applying a Pauli-X operator to a physical qubit in which an X-syndrome occurs based on error syndrome measurement; measuring remaining physical qubits, other than the location of the logical ancilla qubit, in an X-basis; and calculating a multiplication of results measured from the X-operator of the extended magic state logical qubit, and correcting a quantum state of a stabilized magic state logical qubit by applying a logical Z operator to the quantum state when a calculated value corresponds to −1.

Moving the magic state logic qubit may further include when the movement operation process is the X-boundary extension type double-bend movement operation, bending the magic state logical qubit while maintaining the boundary using a single Z-stabilizer, and modifying a stabilizer located at a bending corner to a weight −3 stabilizer.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a method for moving magic states through boundary extension in a rotated surface code according to an embodiment of the present disclosure;

FIGS. 2 and 3 are diagrams illustrating an example of an arrangement structure composed of rotated logical qubits in a two-dimensional (2D) array;

FIG. 4 is a diagram illustrating an example in which magic states are moved through a routing space according to the present disclosure;

FIGS. 5 and 6 are diagrams illustrating an example of unidirectional movement in boundary extension type movement according to the present disclosure;

FIG. 7 is a diagram illustrating an example of a syndrome stabilization process in a Z-boundary extension type movement operation according to the present disclosure;

FIG. 8 is a diagram illustrating an example of Z-boundary extension type single-bend movement;

FIGS. 9 and 10 are diagrams illustrating an example of boundary extension type double-bend movement according to the present disclosure; and

FIGS. 11 to 13 are diagrams illustrating comparisons between execution processes and space-time costs of state teleportation and a boundary extension type movement operation according to the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

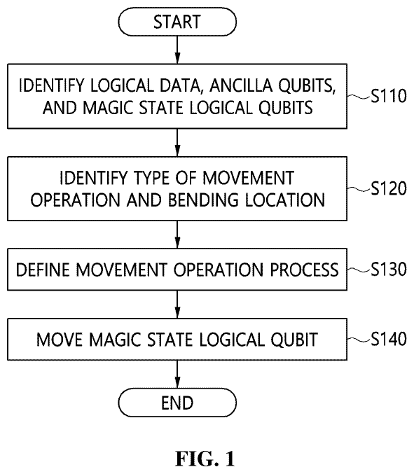

FIG. 1 is a diagram illustrating a method for moving magic states through boundary extension in a rotated surface code according to an embodiment of the present disclosure.

Referring to FIG. 1, the method for moving magic states through boundary extension in a rotated surface code according to the embodiment of the present disclosure identifies logical data and ancilla qubits constituting a logical qubit block, and an available magic state logical qubit from a magic state storage space in an arrangement structure composed of logical qubits in a rotated surface code having a 2D array at step S110.

Here, the present disclosure relates to an operation of implementing a multi-qubit operation requiring magic states. For example, the present disclosure relates to an operation of long-range magic state movement that supports multi-qubit quantum operations in a T or S gate requiring magic states in a quantum circuit based on a logical qubit arrangement structure in the rotated surface code.

Here, the logical data and ancilla qubits that are the target of the multi-qubit operation may be identified based on the arrangement structure.

Here, an available magic state logical qubit in the magic state storage space may be identified.

Further, the method for moving magic states through boundary extension in a rotated surface code according to the embodiment of the present disclosure identifies the type of a movement operation and bending locations during movement by analyzing the path through which the magic state logical qubit is moved to the location of a desired logical ancilla qubit at step S120.

For example, the type of the movement operation and the bending locations for movement may be identified by analyzing information about the previously identified magic state logical qubit and logical ancilla qubits and the movement path thereof.

Here, the type of the movement operation may correspond to any one of a Z-boundary extension type in which the magic state logical qubit is extended and moved based on the Z-boundary of the magic state logical qubit, and an X-boundary extension type in which the magic state logical qubit is extended and moved based on the X-boundary of the magic state logical qubit.

Also, the method for moving magic states through boundary extension in a rotated surface code according to the embodiment of the present disclosure defines a movement operation process based on boundary extension in consideration of the type of the movement operation and the bending locations during movement at step S130.

Here, the movement operation process may correspond to any one of a Z-boundary extension type unidirectional movement operation in which the magic state logical qubit corresponds to the Z-boundary extension type and is moved only in a horizontal direction, an X-boundary extension type unidirectional movement operation in which the magic state logical qubit corresponds to the X-boundary extension type and is moved only in a vertical direction, a Z-boundary extension type double-bend movement operation in which the magic state logical qubit corresponds to the Z-boundary extension type and is moved while bending 2ⁿ times, and an X-boundary extension type double-bend movement operation in which the magic state logical qubit corresponds to the X-boundary extension type and is moved while bending 2ⁿ times, where n in 2ⁿ may be 1 or more.

Furthermore, the method for moving magic states through boundary extension in a rotated surface code according to the embodiment of the present disclosure moves the magic state logical qubit to the location of the corresponding logical ancilla qubit in conformity with the movement operation process at step S140.

Here, whether a logical error is inserted may be tracked, and the moved magic state logic qubit may be corrected using a logical operator based on the result of tracking, thus performing syndrome stabilization.

For example, a syndrome for single quantum state extension for a movement operation may be measured, insertion of a logical error attributable to error correction in a stabilization process may be tracked, and the moved magic state logical qubit may be corrected using a logical operator depending on the result of tracking. This process may support the movement of the magic state logical qubit so that the magic state logical qubit is fault-tolerantly moved by tracking errors that may be inserted in the syndrome stabilization process.

Here, when the movement operation process is the Z-boundary extension type, the movement process may be configured to initialize an uninitialized physical qubit of a routing space present from the Z-boundary of the magic state logical qubit to the location of the logical ancilla qubit to a |0> state, perform syndrome stabilization by applying a Pauli-Z operator to a physical qubit in which a Z-syndrome occurs based on error syndrome measurement, measure the remaining physical qubits, other than the location of the logical ancilla qubit, in the Z-basis, calculate the multiplication of results measured from the Z-operator of the extended magic state logical qubit, and correct the quantum state of a stabilized magic state logical qubit by applying a logical X operator to the quantum state when a calculated value corresponds to −1.

Here, when the movement operation process is the Z-boundary extension type double-bend movement operation, the magic state logical qubit is bent while maintaining the boundary using a single X-stabilizer, wherein a stabilizer located at a bending corner may be modified to a weight-3 stabilizer.

Further, when the movement operation process is the X-boundary extension type, the movement process may be configured to initialize an uninitialized physical qubit of a routing space present from the X-boundary of the magic state logical qubit to the location of the logical ancilla qubit to a |+> state, perform syndrome stabilization by applying a Pauli-X operator to a physical qubit in which an X-syndrome occurs based on error syndrome measurement, measure the remaining physical qubits, other than the location of the logical ancilla qubit, in the X-basis, calculate the multiplication of results measured from the X-operator of the extended magic state logical qubit, and correct the quantum state of a stabilized magic state logical qubit by applying a logical Z operator to the quantum state when a calculated value corresponds to −1.

Here, when the movement operation process is the X-boundary extension type double-bend movement operation, the magic state logic qubit is bent while maintaining the boundary using a single Z-stabilizer, wherein a stabilizer located at a bending corner may be modified to a weight-3 stabilizer.

By means of the magic state movement method, the magic state logical qubit may be moved at a long distance using a routing space composed of physical qubits in the logical qubit arrangement structure in the rotated surface code having a 2D array. This method may move the magic state logical qubit by shortening an execution time compared to the logical operator joint measurement method.

For example, in the logical operator joint measurement, the magic state logical qubit needs to be encoded into a logical qubit in a quantum state suitable for a boundary merging routing spaces. Therefore, as initial encoding cost for encoding the magic state logical qubit into a d logical qubit, 2d³ space-time cost is required.

On the other hand, boundary extension type movement proposed in the present disclosure merely initializes the magic state logical qubit on a physical qubit basis, and does not perform encoding, whereby initialization cost is not necessary. Further, because the movement path may be defined and performed as a movement operation without change, prompt movement processing is possible.

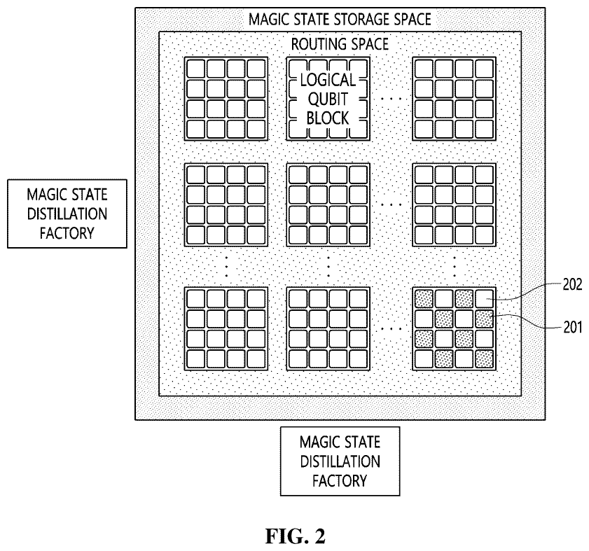

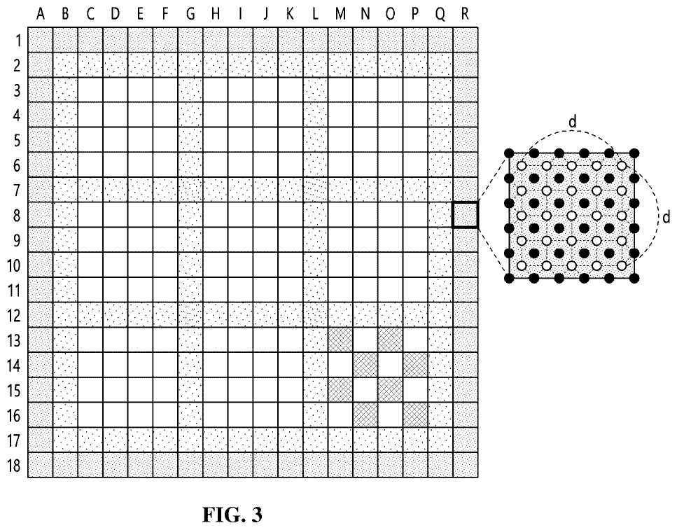

FIGS. 2 and 3 are diagrams illustrating an example of an arrangement structure composed of rotated logical qubits having a 2D array.

Referring to FIG. 2, the arrangement structure in which rotated surface codes having a 2D array are arranged may be composed of a magic state distillation factory, a magic state storage space, a routing space, and logical qubit blocks (hereinafter referred to as LQB).

When a magic state generated in the magic state distillation factory is output to the magic state storage space, the magic state may be moved to a desired location in the LQB on which a quantum gate operation is intended to be performed using the magic state, through the routing space.

In the LQB, logical data 201 and ancilla qubits 202 on which a quantum operation is to be performed may be configured as needed. The magic state may be moved to a location within the routing space adjacent to the LQB, or may be moved to the location of a targeted logical ancilla qubit within the LQB.

The arrangement structure illustrated in FIG. 2 may be defined as a 2D matrix composed of identical d rotated logical qubits 310. By means of this, locations corresponding to A1 to R1, A2 to A17, R2 to R17, and A18 to R18 may be defined as the magic state storage space, and locations corresponding to B2 to Q2, B3 to B16, Q3 to Q16, B17 to Q17, C7 to P7, C12 to P12, G3 to G16, and L3 to L16 may be defined as the routing space.

The logical data 201 and the ancilla qubits 202 of the LQB may be defined by matrix values depending on the location of each block. Therefore, assuming that an identifier (ID) is assigned to each of locations corresponding to A1 to R18 of the 2D matrix, location information, space information, a movement operation type, etc. may be determined using the identifiers (ID), and required movement operations may be performed.

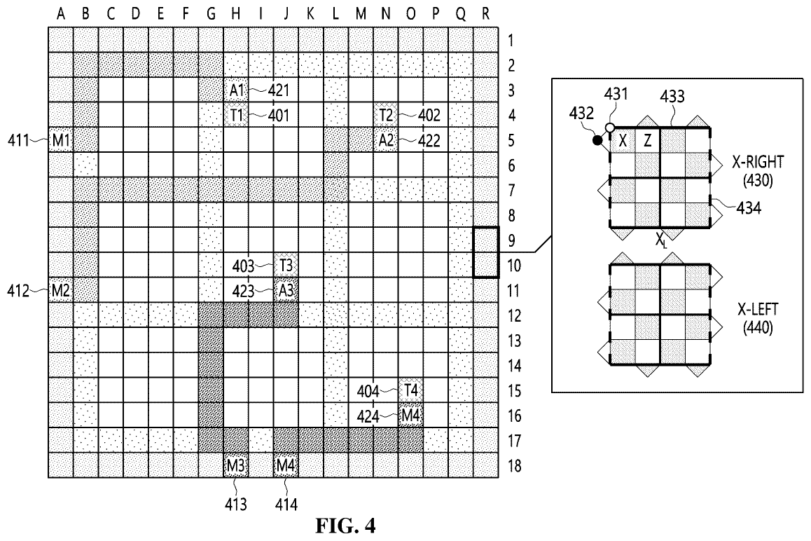

FIG. 4 is a diagram illustrating an example in which magic states are moved through a routing space according to the present disclosure.

Referring to FIG. 4, an example of an operation of moving the magic states through the routing space in the arrangement structure illustrated in FIGS. 2 and 3 is depicted.

Because each of d rotated logical qubits 430 and 440 illustrated in FIG. 4 is composed of d² data qubits 431 and d²-1 syndrome qubits 432, the number of necessary physical qubits may be ≈=2d².

In this case, each syndrome qubit is defined as an X-stabilizer for detecting a phase error (Z-syndrome) or a Z-stabilizer for detecting a bit error (X-syndrome). Further, each syndrome qubit defines an X-boundary (indicated by a solid line) 433 that ends with the X-stabilizer and a Z-boundary (indicated by a dotted line) 434 that ends with the Z-stabilizer, and defines a logical X operator X_{L} by connecting two X-boundaries and a logical Z operator Z_{L} by connecting two Z-boundaries.

FIG. 4 assumes a structure in which the X-RIGHT logical qubit 430 and the X-LEFT logical qubit 440, which have upper/lower X-boundaries and left/right Z-boundaries, are arranged from A1 to A18 to be aligned with boundaries. In addition, Z-RIGHT logical qubits or Z-LEFT logical qubits may also be arranged to be aligned with boundaries depending on the encoding method.

Further, FIG. 4 represents an operation of moving magic state logical qubits M1 to M4 (411 to 414), with which joint measurement is to be performed with logical qubits T1 to T4 (401 to 404) positioned at locations H4, N4, J10, and 015 in a 2D matrix, to ancilla qubits A1 to A4 (421 to 424) positioned at locations H3, N5, J11, and 016.

Here, the magic qubits M1 411 and M2 412 are moved in a quadruple-bending manner to the locations of the ancilla qubits A1 421 and A2 422, respectively, by extending right Z-boundaries thereof. Unlike this, magic state logical qubits M3 413 and M4414 are moved to the locations of the ancilla qubits A3 423 and A4 424 in a quadruple-bending manner and in a double-bending manner, respectively, by extending the upper X-boundaries thereof.

If a magic state logical qubit is located between locations R1 and R18, it may be moved by extending the left Z-boundary thereof, whereas when it is disposed between locations B1 and Q1, it may be moved by extending the lower X-boundary.

The boundary extension type movement method proposed in the present disclosure may broadly define Z-boundary extension type movement and X-boundary extension type movement, and may specifically define unidirectional movement and multi-bend movement.

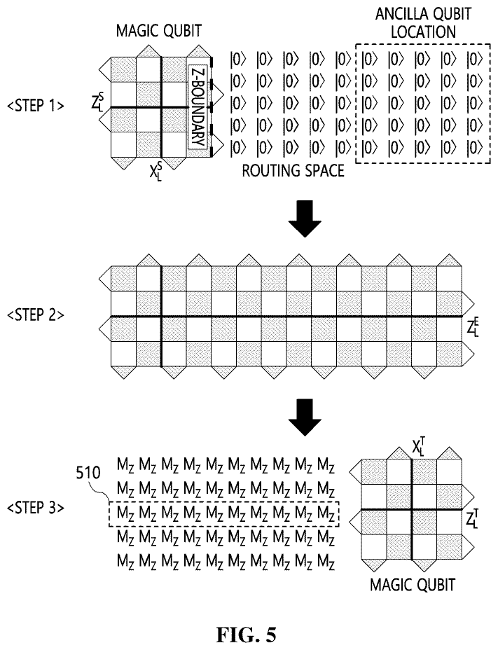

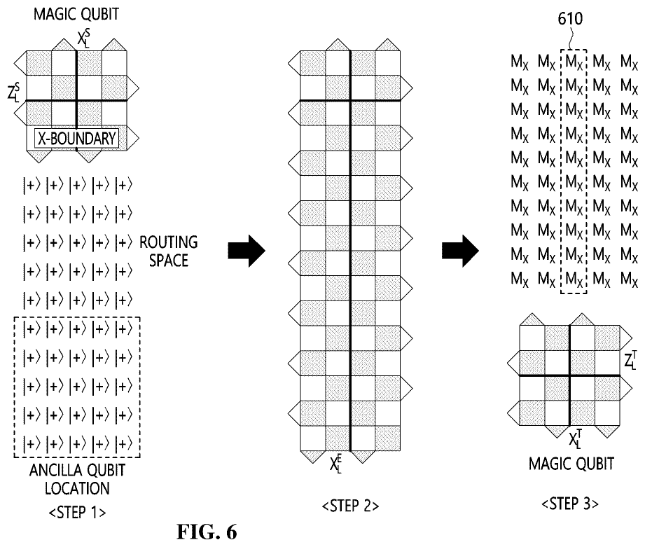

FIGS. 5 and 6 are diagrams illustrating an example of unidirectional movement in boundary extension type movement according to the present disclosure.

In this case, boundary extension type movement refers to technology for encoding logical qubits desired to be moved and physical qubits in a routing space into a single quantum state, and thereafter moving the logical quantum state to a desired location through measurement.

Here, the rotated logical qubits may be defined as various types depending on the encoding scheme. Hereinafter, a unidirectional movement operation process of moving the X-RIGHT logical qubit in boundary extension type movement will be described in detail.

First, FIG. 5 illustrates an example of Z-boundary extension type movement according to the present disclosure, wherein at <STEP 1>, all physical data qubits in the routing space may be initialized to the |0> state so as to extend the Z-boundary of the magic qubits.

Thereafter, at <STEP 2>, error syndrome measurement may be performed so as to form the magic qubits and initialized physical qubits into a single magic state. When a syndrome occurs, the magic qubits and the physical qubits may be stabilized through decoding and error correction. Here, a logical Z operator may be extended from Z_{L}^{S} to Z_{L}^{E}.

Finally, at <STEP 3>, when all stabilizers are stabilized to +1, only the location of the ancilla qubits is left, and the remaining data qubits may be measured in the Z-basis (M_{Z}).

Here, the multiplication of results 510 measured from the extended logical Z operator is calculated. When the value of the multiplication is −1, logical bits may be corrected by applying a logical X operator X_{L}^{T} to the stabilized magic qubits.

Further, FIG. 6 illustrates an example of X-boundary extension type movement according to an embodiment of the present disclosure, wherein at <STEP 1>, all physical data qubits in the routing space may be initialized to the |+> state so as to extend the X-boundary of the magic qubits.

At <STEP 2>, error syndrome measurement may be performed so as to form the magic qubits and initialized physical qubits into a single magic state. When a syndrome occurs, the magic qubits and the physical qubits may be stabilized through decoding and error correction. Here, a logical X operator may be extended from X_{L}^{S} to X_{L}^{E}.

Finally, at <STEP 3>, when all stabilizers are stabilized to +1, only the location of the ancilla qubits is left, and the remaining data qubits may be measured in the X-basis (M_{X}).

Here, the multiplication of results 610 measured from the extended logical X operator is calculated. When the value of the multiplication is −1, logical phases may be corrected by applying a logical Z operator Z_{L}^{T} to the stabilized magic qubits.

FIG. 7 is a diagram illustrating an example of a syndrome stabilization process in a Z-boundary extension type movement operation according to the present disclosure.

Referring to FIG. 7, illustrated is an example in which a logical phase error is inserted in error correction for stabilizing a syndrome occurring in error syndrome measurement according to the present disclosure.

For example, error syndrome measurement including a logical qubit 710 in a stabilized logical |+>_{L} state and a physical qubit 720 in the |0> state is executed. Due to an additional data qubit 720 in the Z-basis state, there is a high probability that a Z-syndrome will occur in a new X-stabilizer 732. When the Z-syndrome occurs, an error correction path is inferred by decoding, and a Pauli-Z operator 731 is applied to the corresponding data qubit to stabilize the syndrome. However, as illustrated in FIG. 7, an error correction operation of stabilizing a new Z-syndrome 730 causes the effect of applying a logical Z operator to the existing logical qubit 710, with the result that a logical phase flip is inserted. Consequently, a logical quantum state moved to a destination 740 becomes a logical state |->_{L} other than the logical state |+>_{L}, thus causing a logical phase error.

For the same reason, in the X-boundary extension type movement operation, the logical quantum state may be moved, with a logical bit error being inserted thereinto, by causing the effect of applying a logical X-operator through error correction using a Pauli-X operator that stabilizes an X-syndrome detected by a new Z-stabilizer 733.

Therefore, technology proposed in the present disclosure includes a technique for tracking whether a logical error is inserted during a process of stabilizing the syndrome of an extended logical qubit, and for correcting the moved logical quantum state using a logical operator depending on the result of the tracking.

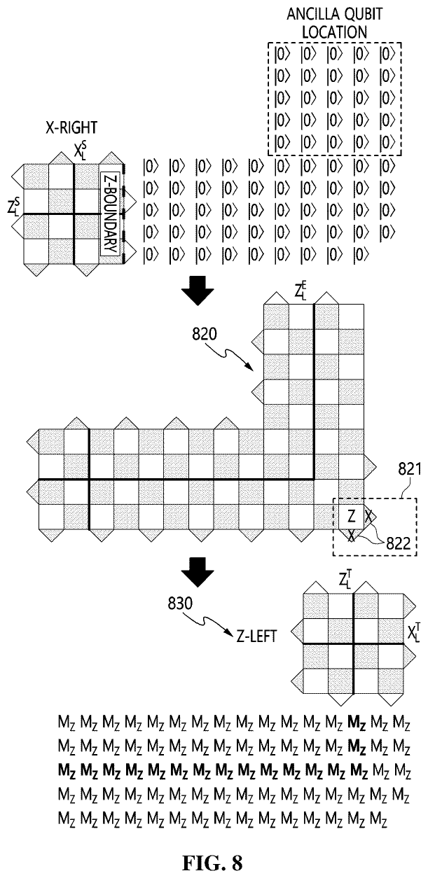

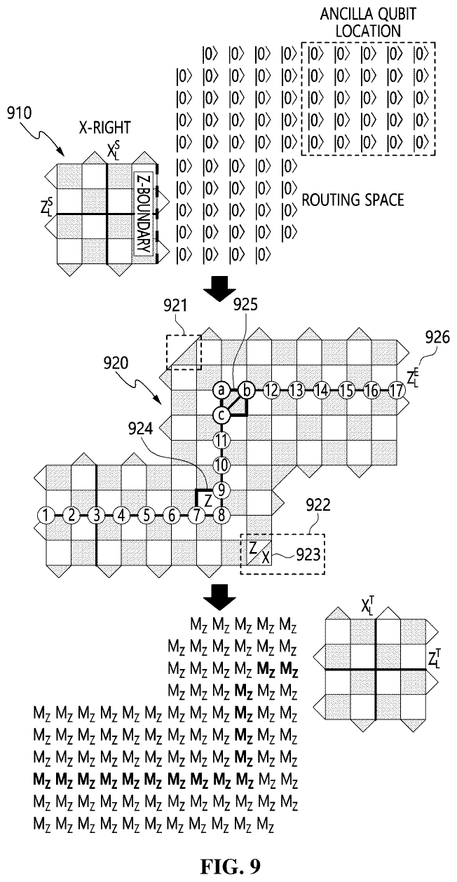

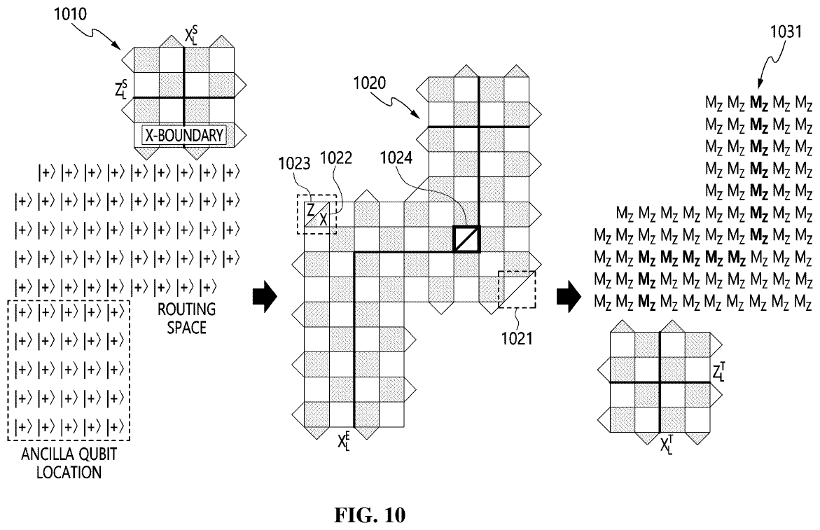

FIGS. 9 and 10 are diagrams illustrating an example of boundary extension type double-bend movement according to the present disclosure.

In order to move a logical qubit to a destination while maintaining the boundary of the logical qubit and a logical operator, even number-based bending needs to be performed, which is defined as double-bend movement.

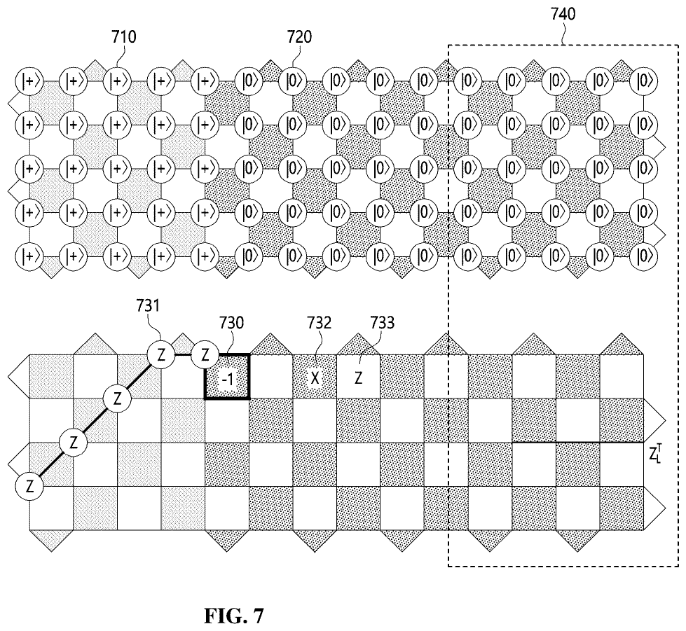

Here, the reason for requiring the even number-based bending is that, when an X-RIGHT logical qubit 810 is single-bent (820), as illustrated in FIG. 8, an X-logical operator is moved to a Z-LEFT logical qubit 830 for which a logical operator is rotated at an angle of 90 degrees. Therefore, bend-movement by which a boundary and a logical operator are maintained needs to be performed as a 2ⁿ-bend movement operation corresponding to an even number unit. Further, the execution process of multi-bend movement for n>1 may be defined in such a way as to combine and extend double-bend movement operation methods for respective boundaries defined in FIGS. 9 and 10 in conformity with paths. When the single-bend movement, illustrated in FIG. 8, is performed an odd number of times, the logical qubit is rotated, whereas when the single-bend movement is performed an even number of times, it may be performed in the same manner as double-bend movement. That is, single double-bend movement may be performed in the same function as a function of performing two single-bend movements.

In this case, the bend-movement operations for respective boundaries, illustrated in FIGS. 9 and 10, follow the same execution procedure as the unidirectional movement operation, described in FIGS. 5 and 6. However, the difference between the double-bend movement operation and the unidirectional movement operation is modification of a stabilizer circuit and definition of a logical operator.

In the unidirectional movement operation, the stabilizer defines basic types, that is, weight-2 and weight-4. Here, weight-m refers to stabilizers constituting a circuit for error detection using m adjacent data qubits.

However, in the bend-movement operation, stabilizers located at bending corners may be modified to weight-3 stabilizers 921 and 1021. That is, as illustrated in FIG. 8, when another type of Z-stabilizer 821 different from that of a boundary is located at the bending corner in a logical qubit that is extended while bending along an X-boundary, the X-boundary may be maintained only when two X-stabilizers 822 are arranged adjacent to the Z-stabilizer.

Here, in the present disclosure, as illustrated in FIG. 9, stabilizers 921 and 922 located at the bending corners may be modified from weight-4 stabilizers to weight-3 stabilizers. In particular, even if the Z-stabilizer 921 different from that of a boundary type is reduced to a single X-stabilizer 923, bend movement may be performed while maintaining the boundary.

In this way, the decrease in the number of data qubits and stabilizers attributable to the modification of the stabilizer may reduce space-time cost required for error syndrome measurement execution. Furthermore, in the case of multi-bend operations having a lot of bending, the number of data qubits and stabilizers may be decreased to the unit of double-bend movement, thus expecting the effect of reducing the total space-time cost.

In the same manner, the X-boundary extension type double-bend movement operation illustrated in FIG. 10 may modify stabilizers 1021 and 1022 located at bending corners from weight-4 stabilizers to weight-3 stabilizers. Therefore, data qubits may be bent while maintaining the boundary using a single Z-stabilizer 1023, thus expecting the effect of reducing space-time cost required for execution.

Here, results measured from the extended logical operator in the execution methods of FIGS. 5 and 6 are defined to be used for post-processing correction so as to fault-tolerantly move logical quantum states. For this operation, in bend movement, a logical operator to be extended needs to be defined in consideration of the type of stabilizer at the bent location.

For example, considering the Z-boundary extension type double-bend movement operation illustrated in FIG. 9, first bending is performed on a Z-stabilizer 924 and second bending is performed on an X-stabilizer 925 in the same manner as the boundary types 921 and 922 of the extended boundary. Here, the Z-stabilizer 924 commutes with a Pauli-Z operator, whereas the X-stabilizer 925 anti-commutes. Therefore, a logical Z operator 926 is defined as an even Pauli-Z operator so that +1 state is maintained for each X-stabilizer between two Z-boundaries. In the same manner, a logical X operator 1031 may be defined in FIG. 10.

FIGS. 11 to 13 are diagrams illustrating comparisons between execution processes and space-time costs of state teleportation and a boundary extension type movement operation according to the present disclosure.

Referring to FIGS. 11 to 13, when a magic state logical qubit (magic qubit) 1110 is moved to a target location 1120 through a routing space 1130, the effect of the present disclosure may be shown in greater detail by comparing the execution processors and space-time costs of state teleportation and the boundary extension type movement operation proposed in the present disclosure.

Here, a logical qubit is defined as a d rotated logical qubit, and a routing space is defined as having a size by which a logical qubit having the same size can be configured. Further, operations that can be processed as physical operations including initialization or measurement upon calculating space-time costs, or as classical operations including the application of a logical X operator or a logical Z operator or the like are excluded from cost calculation.

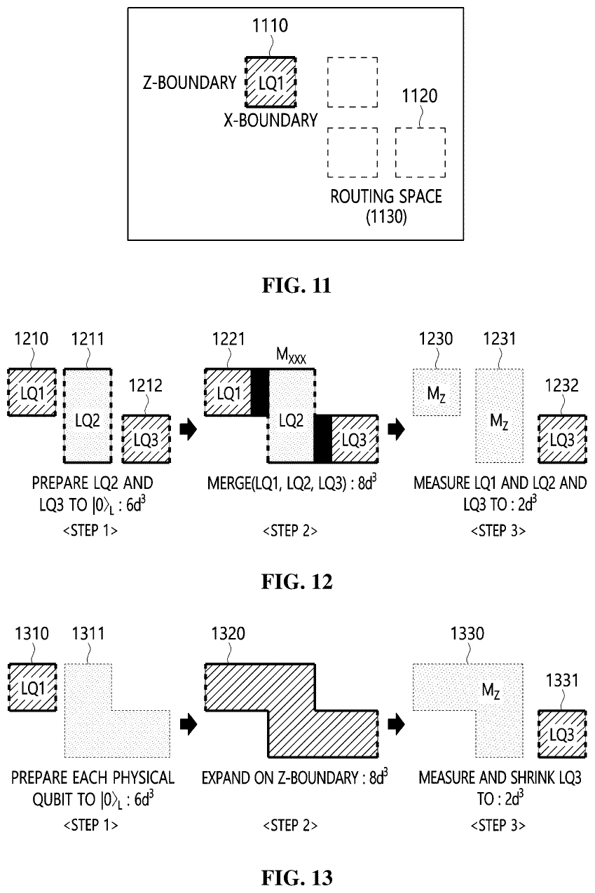

FIG. 12 illustrates the execution process and step-wise space-time costs of logical operator joint measurement-based state teleportation.

At <STEP 1>, in order to maintain the boundary of a magic qubit 1210, logical X operator joint measurement needs to be performed based on a Z-boundary. Accordingly, a routing space is initialized to be separated through two logical qubits LQ2 1211 and LQ3 1212. The reason for this is that, when logical qubits are encoded into a single logical qubit, the boundary of the magic qubit is moved in a shape rotated by 90 degrees. The execution cost of <STEP 1> may be calculated as the sum 6d³ of LQ2 initialization cost 4d³ and LQ3 initialization cost 2d³.

Next, at step <STEP 2>, the magic qubit and two initialized logical qubits are simultaneously merged and measured. This is intended to measure the multiplication of logical X operators of three logical qubits and is defined as M_{XXX} measurement 1221, and execution cost thereof may be calculated as 8d³.

At the last <STEP 3>, the moved magic qubit LQ3 1232 is split by measuring the two logical qubits in the Z-basis (1230 and 1231), and is corrected using a logical operator depending on the result of measurement. In this case, except for measurement that is the physical operation and correction (Pauli correction) that is the classical operation, space-time cost of <STEP 3> may be calculated as the stabilization cost of 2d³ of the moved magic qubit.

Consequently, the total space-time cost required in order to move the magic qubit using the logical operator joint measurement, illustrated in FIG. 12, is 16d³.

FIG. 13 illustrates the execution process and step-wise space-time costs of the Z-a boundary extension type double-bend movement operation.

At <STEP 1>, each physical qubit 1311 in a routing space is initialized into the |0> state. Here, since it is a physical operation, time cost is not present and only space cost is 6d².

Next, at <STEP 2>, at a magic state logical qubit (magic qubit) 1310 and the initialized physical qubit 1311, error syndrome measurement is simultaneously performed (1320), and execution cost is 8d³.

At the last <STEP 3>, a magic qubit 1331 may be extracted from a target location by measuring the data qubit in the Z-basis (1330), and may be corrected using a logical operator depending on the result of measurement. Here, except for the measurement that is the physical operation and correction that is the classical operation, space-time cost at <STEP 3> may be calculated as 2d³ that is the stabilization cost of the moved magic qubit.

Consequently, the total space-time cost of the boundary extension type movement operation according to the present disclosure is 10d³+6d².

That is, comparing FIGS. 12 and 13, the boundary extension type movement operation according to the present disclosure does not need to encode ancilla qubits during an initialization process, compared to the logical operator joint measurement method, with the result that the space-time cost required for initial encoding may be reduced by the size of the routing space increased in proportion to movement distance.

According to the present disclosure, is to fault-tolerantly move magic states to a desired location using a method for extending the boundary of magic state logical qubits using a routing space composed of uninitialized physical qubits within an arrangement structure composed of logical qubits in a rotated surface code having a two-dimensional (2D) array.

Further, the present disclosure may move a magic state qubit at a long distance by shortening the execution time compared to a logical operator joint measurement method.

Furthermore, the present disclosure can define and perform a movement path as a movement operation without change, thus enabling prompt movement processing of magic state qubits.

As described above, in the method for moving magic states through boundary extension in a rotated surface code according to the present disclosure, the configurations and schemes in the above-described embodiments are not limitedly applied, and some or all of the above embodiments can be selectively combined and configured so that various modifications are possible.

What is claimed is:

1. A method for moving magic states in an arrangement structure composed of logical qubits in a rotated surface code having a two-dimensional (2D) array, comprising:
identifying logical data and an ancilla qubit constituting a logical qubit block, and an available magic state logical qubit from a magic state storage space;
identifying a type of a movement operation and a bending location during movement by analyzing a path through which the magic state logical qubit is moved to a location of a desired logical ancilla qubit;
defining a movement operation process based on boundary extension in consideration of the type of the movement operation and the bending location during the movement; and
moving the magic state logical qubit to the location of the logical ancilla qubit in conformity with the movement operation process.

2. The method of claim 1, wherein the movement operation type corresponds to any one of a Z-boundary extension type in which the magic state logical qubit is extended and moved based on a Z-boundary of the magic state logical qubit, and an X-boundary extension type in which the magic state logical qubit is extended and moved based on an X-boundary of the magic state logical qubit.

3. The method of claim 2, wherein the movement operation process corresponds to any one of a Z-boundary extension type unidirectional movement operation in which the magic state logical qubit corresponds to the Z-boundary extension type and is moved only in a horizontal direction, an X-boundary extension type unidirectional movement operation in which the magic state logical qubit corresponds to the X-boundary extension type and is moved only in a vertical direction, a Z-boundary extension type double-bend movement operation in which the magic state logical qubit corresponds to the Z-boundary extension type and is moved while bending 2ⁿ times, and an X-boundary extension type double-bend movement operation in which the magic state logical qubit corresponds to the X-boundary extension type and is moved while bending 2ⁿ times, where n in 2ⁿ may be 1 or more.

4. The method of claim 3, wherein moving the magic state logical qubit comprises:
performing syndrome stabilization by tracking whether a logical error is inserted and by correcting the moved magic state logical qubit using a logical operator depending on a result of tracking.

5. The method of claim 4, wherein moving the magic state logical qubit further comprises:
when the movement operation process is the Z-boundary extension type,
initializing an uninitialized physical qubit of a routing space, present from the Z-boundary of the magic state logical qubit to the location of the logical ancilla qubit, to a |0> state;
performing syndrome stabilization by applying a Pauli-Z operator to a physical qubit in which a Z-syndrome occurs based on error syndrome measurement;
measuring remaining physical qubits, other than the location of the logical ancilla qubit, in a Z-basis; and
calculating a multiplication of results measured from the Z-operator of the extended magic state logical qubit, and correcting a quantum state of a stabilized magic state logical qubit by applying a logical X operator to the quantum state when a calculated value corresponds to −1.

6. The method of claim 5, wherein moving the magic state logic qubit further comprises:
when the movement operation process is the Z-boundary extension type double-bend movement operation,
bending the magic state logical qubit while maintaining a boundary using a single X-stabilizer, and modifying a stabilizer located at a bending corner to a weight-3 stabilizer.

7. The method of claim 4, wherein moving the magic state logic qubit further comprises;
when the movement operation process is the X-boundary extension type,
initializing an uninitialized physical qubit of a routing space, present from the X-boundary of the magic state logical qubit to the location of the logical ancilla qubit, to a |+> state;
performing syndrome stabilization by applying a Pauli-X operator to a physical qubit in which an X-syndrome occurs based on error syndrome measurement;
measuring remaining physical qubits, other than the location of the logical ancilla qubit, in an X-basis; and
calculating a multiplication of results measured from the X-operator of the extended magic state logical qubit, and correcting a quantum state of a stabilized magic state logical qubit by applying a logical Z operator to the quantum state when a calculated value corresponds to −1.

8. The method of claim 7, wherein moving the magic state logic qubit further comprises;
when the movement operation process is the X-boundary extension type double-bend movement operation,
bending the magic state logical qubit while maintaining the boundary using a single Z-stabilizer, and modifying a stabilizer located at a bending corner to a weight-3 stabilizer.
